(19) United States
(12) Patent Application Publication
(10) Pub. No.: US 2026/0285209 A1
(43) Pub. Date: Sep. 24, 2026

(54) VEHICLE SEAT RESTRAINT CONTROL MODULE DISCOVERY ON A COMMUNICATION BUS AND CONTROL

(71) Applicant: Veoneer US Safety Systems, LLC, Southfield, MI (US)

(72) Inventors: Haitham ISLIM, Canton, MI (US); Carl Munch, Troy, MI (US)

(73) Assignee: Veoneer US Safety Systems, LLC, Southfield, MI (US)

(21) Appl. No.: 19/084,947

(22) Filed: Mar. 20, 2025

(51) Int. Cl. B60N 2/427; B60R 21/01; B60R 21/015

(52) U.S. Cl. CPC B60N 2/4279; B60R 21/01554; B60R 2021/01034; B60R 2021/01054

(57) ABSTRACT

A control module of a seat of the vehicle is configured to selectively actuate restraints of the seat. A module is configured to, in response to the control module receiving power and being connected to a communication bus: receive a unique identifier from the control module via a request message on the communication bus; determine whether the unique identifier is associated with a bus identifier in memory; when the unique identifier is associated with the bus identifier in memory, transmit an acknowledgement message including the unique identifier and the bus identifier associated with the unique identifier; and when the unique identifier is not associated with any bus identifier in the memory: associate, in the memory, a unique bus identifier not already in the memory with the unique identifier; and transmit the acknowledgement message including the unique identifier and the bus identifier associated with the unique identifier.

### FIELD

The present disclosure relates to vehicle restraint control systems and methods and more particularly to systems and methods for controlling restraints of vehicles with variable seat configurations, positions, and/or orientations.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Vehicles include occupant restraints that are configured to restrain vehicle occupants, such as for vehicle collisions. One type of restraint is a seatbelt. A seatbelt pretensioner may be actuated to tighten a seatbelt under some circumstances, such as in response to detection of a collision.

Another type of restraint is an airbag. A vehicle may include multiple different types of airbags. An inflation device may be actuated (e.g., ignited) to inflate an airbag under some circumstances, such as in response to detection of a collision.

### SUMMARY

In a feature, a restraint control system of a vehicle includes: a communication bus; a control module of a seat of the vehicle configured to selectively actuate restraints of the seat; and a module configured to, in response to the control module of the seat receiving power and being connected to the communication bus: receive a unique identifier from the control module of the seat via a request message on the communication bus; determine whether the unique identifier is associated with a bus identifier in memory; when the unique identifier is associated with the bus identifier in memory of the module, transmit on the communication bus an acknowledgement message including (a) the unique identifier and (b) the bus identifier associated with the unique identifier; and when the unique identifier is not associated with any bus identifier in the memory: associate, in the memory, a unique bus identifier not already in the memory with the unique identifier; and transmit on the communication bus the acknowledgement message including (a) the unique identifier and (b) the bus identifier associated with the unique identifier.

In further features, the unique identifier is a serial number.

In further features: the module is configured to authenticate communication with the control module of the seat; and the control module of the seat is configured to authenticate communication with the module.

In further features, the control module of the seat is configured to: receive from the bus (a) the unique identifier and (b) the bus identifier associated with the unique identifier; determine whether the unique identifier received from the communication bus is the same as the unique identifier; store the bus identifier in second memory of the control module; and set communication bus identifiers based on the bus identifier of the seat.

In further features, the control module of the seat is configured to force a reset of itself before the setting the communication bus identifiers.

In further features: the memory of the module is reset protected random access memory (RPRAM); and the second memory of the control module is RPRAM.

In further features, the control module is configured to periodically output the communication bus identifiers to the communication bus.

In further features, the control module is configured to ignore messages on the communication bus with unique identifiers that are different than the unique identifier.

In further features: a second control module of a second seat of the vehicle configured to selectively actuate second restraints of the second seat, where the module is further configured to, in response to the second control module of the second seat receiving power and being connected to the communication bus: receive a second unique identifier from the second control module of the second seat via a second request message on the communication bus; determine whether the second unique identifier is associated with a bus identifier in memory; when the second unique identifier is associated with the bus identifier in memory of the second module, transmit on the communication bus a second acknowledgement message including (a) the second unique identifier and (b) the bus identifier associated with the second unique identifier; and when the second unique identifier is not associated with any bus identifier in the memory: associate, in the memory, a second unique bus identifier not already in the memory with the second unique identifier; and transmit on the communication bus the second acknowledgement message including (a) the second unique identifier and (b) the bus identifier associated with the second unique identifier.

In further features, no bus identifiers are associated with unique identifiers in the memory in response to the vehicle transitioning from OFF to ON.

In further features, the seat is configured to engage pairs of tracks of a floor of a passenger cabin of the vehicle, the pairs of tracks arranged parallel to a longitudinal axis of the vehicle, and the pairs tracks are configured to engage two or more seats on each pair of tracks.

In further features, a restraint control module is configured to, in response to detection of a collision of the vehicle: set indicators of International Standards Organization (ISO) codes for the collision; and broadcast the indicators of the ISO codes to the communication bus.

In further features, the control module of the seat is configured to: receive the indicators of the ISO codes via the communication bus; select which ones of the restraints of the seat to actuate based on a position of that seat and the indicators of the ISO codes; actuate the selected restraints of that seat; and not actuate non-selected ones of the restraints of that seat.

In further features, the ISO codes are longitudinal row, latitudinal position, and restraint specific.

In further features, the module is further configured to: determine the position of the seat within the passenger cabin of the vehicle; and transmit the position of the seat to the seat via the communication bus.

In further features, the module is further configured to determine whether the one of the seats is compatible based on the unique identifier of the one of the seats.

In further features: the control module of the seat is further configured to transmit a type of the seat to the module via the communication bus; and the module is further configured to determine whether the one of the seats is compatible based on the type of the seat.

In further features: the control module of the seat is further configured to transmit a manufacturer of that seat to the module via the communication bus; and the module is further configured to determine whether the seat is compatible based on the manufacturer of the seat.

In further features, only the request message from the control module can occupy the communication bus at a time.

In a feature, a restraint control method for a vehicle includes: by a control module of a seat of the vehicle, selectively actuating restraints of the seat; and by a module separate from the control module, in response to the control module of the seat receiving power and being connected to a communication bus: receiving a unique identifier from the control module of the seat via a request message on the communication bus; determining whether the unique identifier is associated with a bus identifier in memory; when the unique identifier is associated with the bus identifier in memory of the module, transmitting on the communication bus an acknowledgement message including (a) the unique identifier and (b) the bus identifier associated with the unique identifier; and when the unique identifier is not associated with any bus identifier in the memory: associating, in the memory, a unique bus identifier not already in the memory with the unique identifier; and transmitting on the communication bus the acknowledgement message including (a) the unique identifier and (b) the bus identifier associated with the unique identifier.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a top view of an example vehicle;

FIG. 2 is a functional block diagram of a portion of a seat;

FIG. 3 is another top view of the vehicle;

FIG. 4 is a functional block diagram of an example portion of the vehicle;

FIG. 5 is a flowchart depicting an example method of controlling restraint actuation;

FIG. 6 is an illustration of an example seat arrangement and right side collision;

FIG. 7 is an illustration of an example seat arrangement and right side collision;

FIG. 8 is an illustration of an example seat arrangement and right side collision;

FIG. 9 is an illustration of an example seat arrangement and offset front side collision;

FIG. 10 is an illustration of an example seat arrangement and rear collision;

FIG. 11 includes an example cross-sectional view of a track and a gear that engages teeth in the track;

FIG. 12 includes example tables of actuation indicators (Y/N) for each restraint (R1-RM) for different seat occupancies, collision direction/locations, seat facing directions, and seat positions;

FIG. 13 is a cross sectional view including the first pair of tracks and a base of a seat;

FIG. 14 incudes a functional block diagram of an example communication system of the vehicle;

FIG. 15 includes a flowchart depicting an example method of discovery of a seat and bus identifier assignment;

FIG. 16 includes a flowchart depicting an example method of controlling actuation of the restraints of seats;

FIG. 17 includes a functional block diagram of an example of the communication system before the discovery process; and

FIG. 18 includes functional block diagram of an example of the communication system after the discovery process.

In the drawings, reference numbers may be reused to identify similar and/or identical elements.

### DETAILED DESCRIPTION

Vehicle restraints can be actuated in response to detection of a collision of the vehicle with another object. For example, airbags and seat pretensioners may be actuated in response to detection of a frontal collision of the vehicle.

Some vehicles, however, can include variable seat configurations. For example, seats may be linearly moveable forward and backward within a passenger cabin of a vehicle along parallel tracks. Additionally, vehicle seats may be removeable from and addable to a vehicle. Additionally, vehicle seats may be positionable (e.g., rotatable) in two or more different directions (e.g., rotational orientations), such as a forward direction of the vehicle, a rearward direction of the vehicle, and angularly rotated positions between forward and rearward.

The present application involves a restraint control module that selects where and which types of restraints to actuate. This may increase occupant protection in the event of a collision while also not unnecessarily actuate restraints when not needed, such as given seat positions, occupancy status, and/or seat orientation.

The present application also involves discovery of modules of seats by the restraint control module for communication via a communication bus.

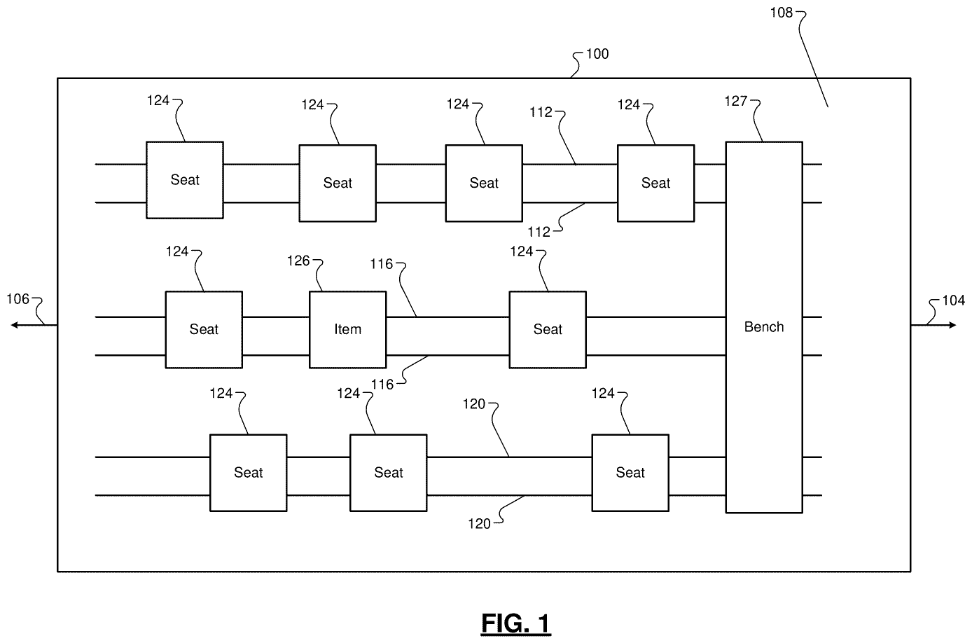

FIG. 1 is a top view of an example vehicle 100. The vehicle 100 may be a vehicle including an internal combustion engine for propulsion, an electric vehicle including one or more electric motors not including an internal combustion engine for propulsion, a hybrid vehicle including one or more electric motors and an internal combustion engine for propulsion, or another suitable type of vehicle. The vehicle 100 may be an autonomous vehicle, a non-autonomous vehicle, or a semi-autonomous vehicle. The vehicle 100 may be a shared vehicle or may be a non-shared vehicle.

The vehicle 100 includes one or more propulsion devices, such as at least one of an electric motor and an internal combustion engine, that generate propulsion torque that is used to propel the vehicle 100. Forward and backward directions of the vehicle 100 are illustrated by arrows 104 and 106. In vehicles that do not have a designated front and rear, front and rear (or back) may be interchangeable and may be expressed relative to the (e.g., present) motion of the vehicle.

The vehicle 100 includes a passenger cabin 108. One or more pairs of tracks are formed in a floor of the passenger cabin 108. For example, the vehicle 100 includes a first pair of tracks 112, a second pair of tracks 116, and a third pair of tracks 120. While the example of three pairs of tracks is provided, the present application is also applicable to one pair of tracks, two pairs of tracks, and more than three pairs of tracks. The tracks of each pair of tracks are parallel. For example, the tracks of the first pair of tracks 112 are parallel. In various implementations, the pairs of tracks may be arranged parallel to the forward and backward directions.

One or more seats 124 are coupled to pairs of tracks. While an example numbers and arrangement of seats is shown in FIG. 1, the present application is also applicable to other numbers and arrangements of seats. The seats 124 may be removable and decouplable from the tracks such that seats can be added to or removed from the passenger cabin 108. For example, the seats 124 may include latches that can be actuated to couple and decouple a seat from tracks. In various implementations, other types of modular items (e.g., tables, workstations, etc.) such as item 126 may be couplable and uncouplable to and from pairs of tracks. Another type of seat is bench seat 127, which includes seating for more than one occupant. Bench seats may be coupled to tracks of different pairs. For example, bench seat 127 is coupled to one track of the first pair of tracks 112 and to one track of the third pair of tracks 120. For simplicity, herein, bench seats, seats, workstations, charging stations, consoles, and other modular items that can be coupled to a pair of tracks may be referred to as a seat.

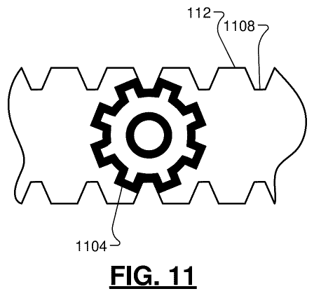

The tracks may be parallel to a longitudinal axis of the vehicle 100 and parallel to a longitudinal direction of the vehicle 100. The seats 124 are moveable linearly along the tracks to which they are coupled. The seats 124 may each include an electric motor that is configured to linearly move its seat along the pair of tracks to which the seat is coupled. For example, the tracks may include teeth, and the electric motor of a seat may drive gears that engage the teeth of the tracks to move the seat linearly. The seats 124 may also be positionable facing one, two, or more than two different directions. For example, the seats 124 may be positionable to face the direction 104 and positionable to face the direction 106. The seats 124 may also be positionable to face other directions between the directions 104 and 106. FIG. 11 includes an example cross-sectional view of a track 112 and a gear 1104 of a seat, where the gear 1104 engages teeth 1108 in the track 112. An electric motor may rotate the gear 1104 to move the seat forward or backward along the track 112. While an example gear and track system is provided, the present application is also applicable to other types of gear systems, such as worm gears.

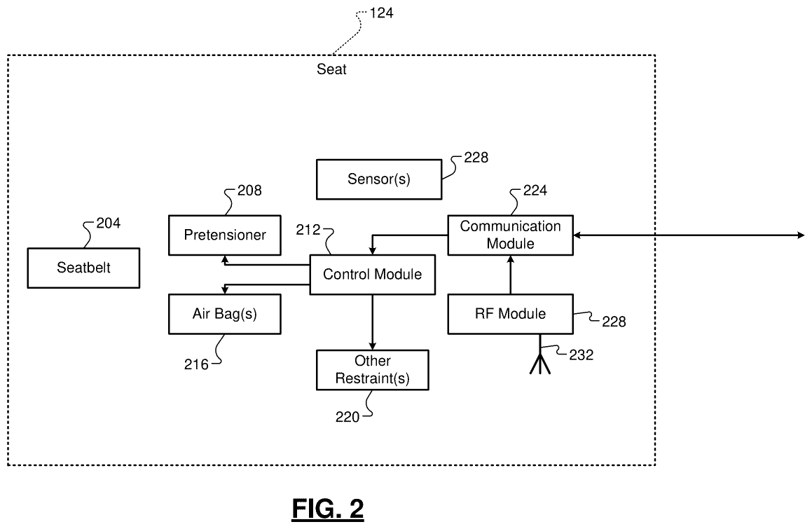

FIG. 2 is a functional block diagram of a portion of a seat 124 (seat, bench seat, workstation, charging station, item, etc.). Each of the seats 124 may include the same modules and may include the same or different restraints.

The seat 124 includes one or more seatbelts, such as seatbelt 204, that configured to belt a passenger to the seat 124. The seat 124 includes one or more pretensioners, such as pretensioner 208, that tighten the seatbelt 204 when actuated by a control module 212. The seat 124 may include one or more airbags 216, such as a seatbelt airbag, one or more seat side (e.g., curtain) airbags, hip airbags, occupant to occupant airbags, and/or one or more other suitable types of airbags. The seat 124 may also include one or more other restraints 220, such as one or more active head rests. Each seat knows which restraints it includes.

The control module 212 selectively actuates the pretensioner 208, actuation of the airbag(s) 216, and the other restraint(s) 220 (collectively referred to as “restraints”). The control module 212 may actuate one or more of the restraints of the seat 124 based on communication received via a communication module 224.

The communication module 224 communicates with other modules of the vehicle, such as discussed further below. In various implementations, the communication module 224 may be separate from the seat 124.

The seat 124 may include a radio frequency (RF) module 228. The RF module 228 includes an RF receiver and may include an RF transmitter. In various implementations, the RF module 228 may include an RF transceiver. The RF module 228 receives RF signals via one or more antennas, such as antenna 232. The RF module 228 may determine a signal strength indicator (value), such as a relative signal strength indicator (RSSI) based on characteristics of RF signals received. The signal strength indicator of a received RF signal and a unique identifier of an RF transmitter that transmitted the received signal may be communicated to one or more modules, such as discussed further below.

Signal strength indicators of multiple RF signals received from multiple different RF transmitters may be used by a position module to determine a position of the seat 124 within the passenger cabin 108. Additionally or alternatively, the position of the seat 124 may be determined based on one or more other types of data. For example, a position sensor (e.g., a variable reluctance or Hall effect sensor) may determine a linear position of the seat 124 based on rotation of the gears driven by the electric motor of the seat 124. The position sensor may, for example, increment or decrement the linear position of the seat 124 based rotation of the gear(s) coupled to the tracks of the seat. The position of the seat 124 may be determined based on the linear position of the seat 124 on its pair of tracks and predetermined position information of the pair of tracks. Additionally or alternatively, one or more cameras may be used to capture images of the passenger cabin 108, and the position of the seat 124 may be determined based on the positions of the seat 124 within the image(s), for example, using a lookup table and/or an equation. Additionally or alternatively, encoders may be provided along each track, and the outputs of the encoders may be used to determine the positions of the seats. The seats may also include a mass sensor that measures a mass present on the seat. A restraint control module may determine whether a seat is occupied based on images captured using a camera (e.g. the seat includes an object having a shape of a human), using the masses measured by the mass sensors (e.g., the mass is greater than a predetermined mass), or in another suitable manner. In various implementations, seat belt buckling (or buckle status) may be detected using an image from a camera, from a seat belt sensor, or in another suitable manner. The restraint control module may control actuation of airbags and/or restraints based on whether a seat is occupied and whether a seatbelt is buckled around an occupant of a seat or not.

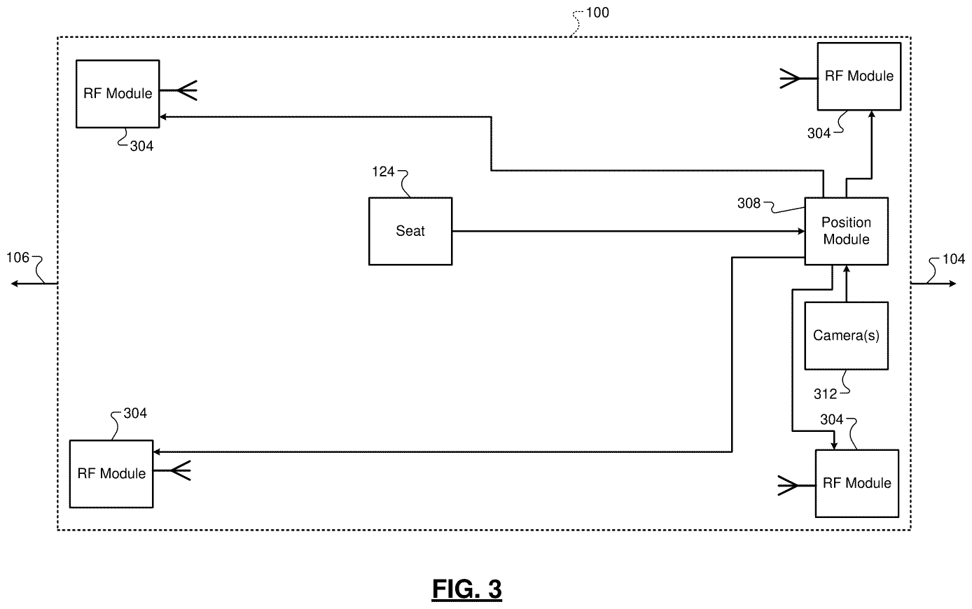

FIG. 3 is another top view of the vehicle 100. Multiple RF modules 304 selectively may transmit RF signals and their respective unique identifiers within the passenger cabin 108, such as when prompted by a position module 308. The RF modules 304 may be located, for example, at front and rear left and right sides of the vehicle 100. The RF modules 304 transmit RF signals via one or more antennas, respectively.

The RF modules of the seats 124, such as the RF module 228 (FIG. 2) receive RF energy and determine signal strength indicators based on the received signals, respectively, from the RF modules 304. The RF modules of the seats 124 communicate the signal strength indicators and the received unique identifiers (e.g., BUS identifiers), respectively, to the position module 308. The position module 308 may determine the locations of the RF modules 304 based on the unique identifiers, respectively. The position module 308 may determine the (present) position of the seat 124 within the passenger cabin 108 based on the signal strength indicators for the RF modules 304 and the locations of the RF modules 304, such as using triangulation. While the example of four RF modules 304 is provided, the present application is also applicable to three RF modules and more than four RF modules. For example, distance to a RF module may increase as the signal strength indicator decreases and vice versa. While the example of transmitting signal strength indicators is provided, the RF modules of the seats 124 may transmit another suitable indicator of the received RF energy. This may allow for a normalized energy to be used.

Additionally or alternatively, the position module 308 may determine the position of the seat 124 based on the measurements from the position sensor of the seat 124. Additionally or alternatively, the position module 308 may determine the position of the seat 124 based on images of the passenger cabin 108 captured using one or more cameras 312. For example, the position module 308 may detect the seat 124 in an image captured using a camera using an object detection algorithm. The position module 308 may determine the position of the seat 124 within the passenger cabin 108, for example, based on a number of pixels of an image occupied by the seat 124 and a pixel location of the seat 124 in the image.

In various implementations, the position module 308 may set the position of a seat to a longitudinal position such as a row (e.g., row 1, row 2, row 3, etc.) and a left to right (latitudinal) position (e.g., left, center, or right). The position module 308 may set the position to the row based on the longitudinal position of the seat. The position module 308 may set the left to right position based on which pair of tracks the seat is in (e.g., first pair 112=left, second pair 116=center, third pair 120=right). Seat positions allow for correlation between seat position and International Standards Organization (ISO) codes. ISO codes identify each device for each position, such as by device, row, and side of the vehicle. An example ISO code specific to driver's side, second row, pretensioner. Another example ISO code is specific to passenger side, third row, airbag.

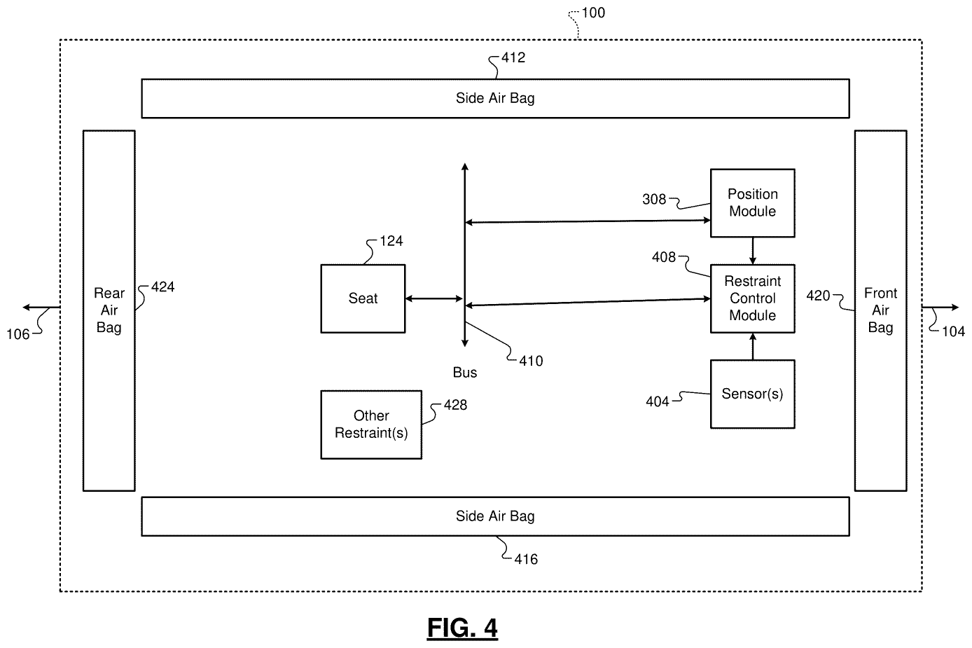

FIG. 4 is a functional block diagram of an example portion of the vehicle 100. The vehicle 100 includes one or more sensors 404 that indicate when a collision between the vehicle 100 and an object occur. The sensors 404 may be, for example, accelerometers or another suitable type of collision sensor. In various implementations, the vehicle 100 may include a sensor configured to indicate when a frontal collision of the vehicle 100 occurs, a sensor configured to indicate when a rear collision of the vehicle 100 occurs, a sensor configured to indicate when a left side collision of the vehicle 100 occurs, and a sensor configure to indicate when a right side collision of the vehicle 100 occurs. The vehicle 100 may include one or more other sensors that indicate when one or more other collisions occur.

The vehicle 100 includes one or more airbags, such as a left side airbag 412, a right side airbag 416, a front airbag 420, a rear airbag 424. While example airbags are shown, the vehicle 100 may additionally include one or more other airbags, such as overhead airbags. In various implementations, the vehicle 100 may include multiple left side airbags, multiple right side airbags, and/or multiple front airbags. The vehicle 100 may also include one or more other restraints 428. While example airbags and restraints are provided, the present application is also applicable to other arrangements of airbags and/or restraints. Also, one or more airbags and/or one or more restraints may be included with one, more than one, or each seat, such as discussed above.

A restraint control module 408 and the position module 308 communicate with the seats 124 via a communication bus 410, such as a controller area network (CAN) bus or another suitable type of vehicle bus. The restraint control module 408 selectively communicates ISO codes regarding locations and restraints to actuate. As discussed above, the control modules 212 of the seats 124 may selectively actuate one or more of the restraints of the seats 124, respectively, based on the ISO codes.

When a collision occurs, the restraint control module 408 determines which ISO codes to issue for the collision and transmits a message including indicators for each ISO code to the seats 124 via the bus 410. For example, N ISO code indicators may be set by the restraint control module 408 for a collision, where N is an integer greater than 1 (e.g., N=16). Each ISO code specifies a row (e.g., Row 1, Row 2, Row 3, etc.), a side of the vehicle (e.g., left or right), and a restraint type (e.g., pretensioner, air bag, etc.). An example of an ISO code is for left side, second row, pretensioner. The indicator for each ISO code may be for example a Boolean, such as a 0 indicating not to actuate and a 1 indicating to actuate. Based on their positions and orientations, the seats 124 each determine which (if any) of its restraints to actuate according to the ISO code indicators (e.g., the ISO codes indicating to actuate). The restraint control module 408 may set the indicators for the ISO codes using a lookup table that relates collision directions, seat positions, seat occupancy, and seat directions to which restraints to actuate and not actuate.

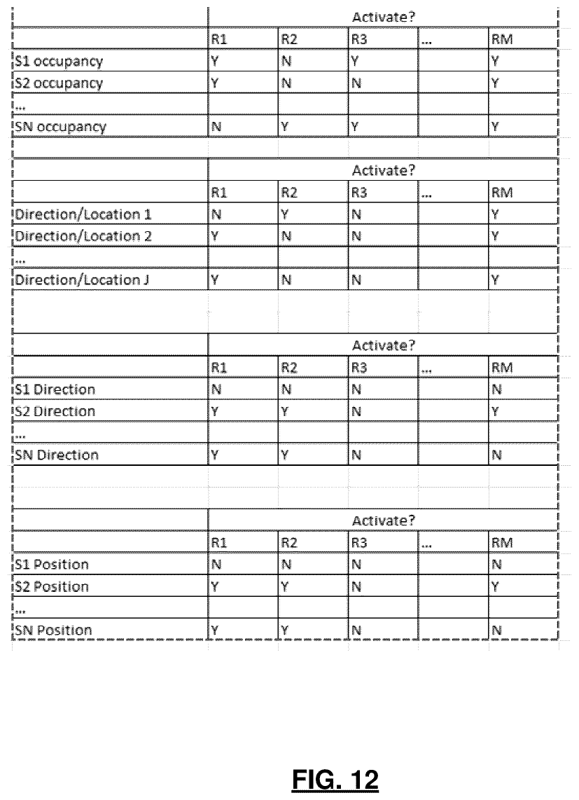

FIG. 12 includes example tables of actuation indicators (Y/N) for each restraint (R1-RM) for different seat occupancies, collision direction/locations, seat facing directions, and seat positions. The restraint control module 408 may determine the indicators for the ISO codes using one or more example tables similar to those of FIG. 12. For example, the rows may be collision direction, and the columns may be specific to side, row, and actuator. Based on the ISO codes, the control modules 212 of the respective seats determine whether to actuate restraints of that seat based on the seat's respective position and orientation.

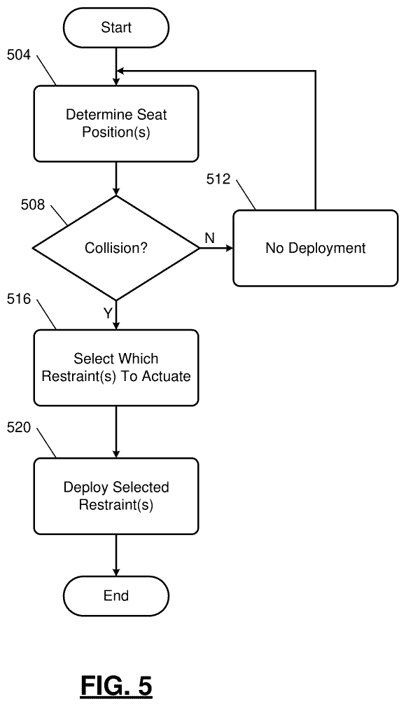

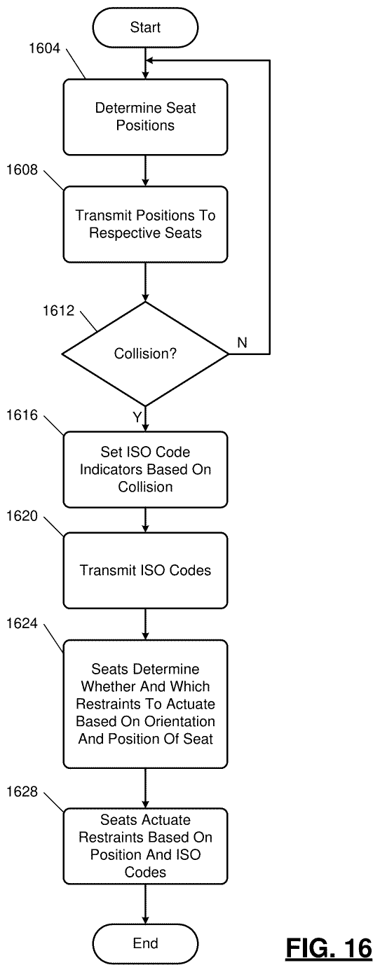

FIG. 5 is a general flowchart depicting an example method of controlling restraint actuation. FIG. 16 includes a more specific flowchart of an example method of controlling restraint actuation.

Referring to FIG. 5, control begins with 504 where the position module 308 determines the positions of the seats 124 within the passenger cabin 108. The position module 308 also determines directions that the seats 124 are facing. For example, the position module 308 triggers the RF modules 304 to at different times (e.g., in a predetermined order) output RF signals and their unique identifiers. The RF modules 228 of the seats 124 determine signal strength indicators for each RF signal received and transmit the signal strength indicators and the unique identifiers. The position module 308 determines the positions of the seats 124, respectively, based on the signal strength indicators of the RF signals received from the RF modules 304, respectively, and the positions of the RF modules 304, such as using triangulation. Additionally or alternatively, the position module 308 may determine the positions (e.g., longitudinal and latitudinal, such as pair of tracks) of the seats 124, respectively, based on images of the passenger cabin 108 and/or the positions measured by the position sensors of the seats 124, respectively.

At 508, the restraint control module 408 determines whether a collision of the vehicle 100 with one or more objects have occurred and, if so, a direction (e.g., front, rear, right side, left side, etc.) of the collision. If 508 is true, control continues with 516. If 508 is false, the restraint control module 408 may determine to not actuate any restraints at 512, and control may return to 504.

At 516, the restraint control module 408 sets the indicators of the ISO codes, such as based on the collision, the collision direction. At 520, the control modules 212 of the seats 124 determine which of their respective restraints to actuate based on the ISO code indicators and actuate the determined restraint(s). One loop is shown in FIG. 5, and control returns to 504.

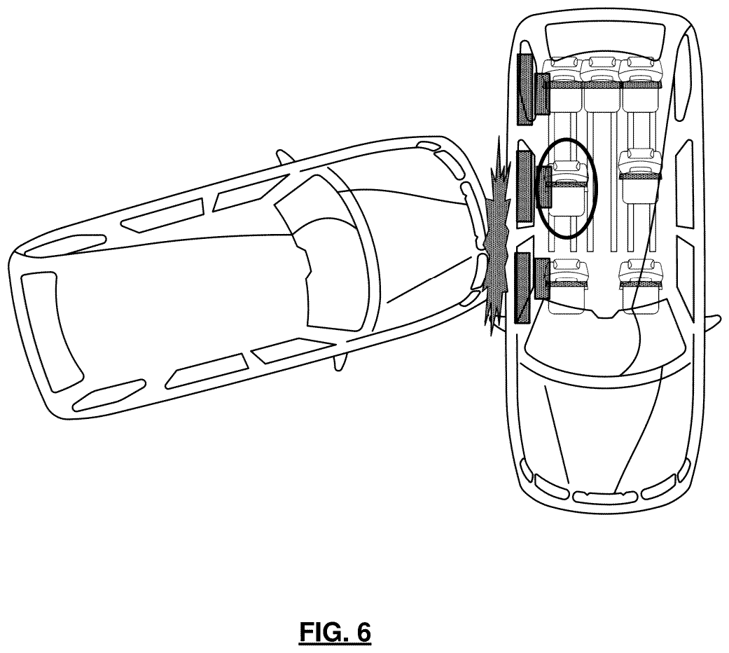

FIG. 6 is an illustration of an example seat arrangement and side (right side) collision. In this example, all of the seats are facing the forward direction. For the example of FIG. 6, based on the seat directions, the collision direction, the seat occupancy, etc., the restraint control module 408 may actuate right side curtain airbags for all rows, the pretensioners for all of the seats, and seat side airbags of the seats on the right most side of the vehicle (where the collision occurred). In various implementations, the restraint control module 408 may not actuate restraints of unoccupied seats.

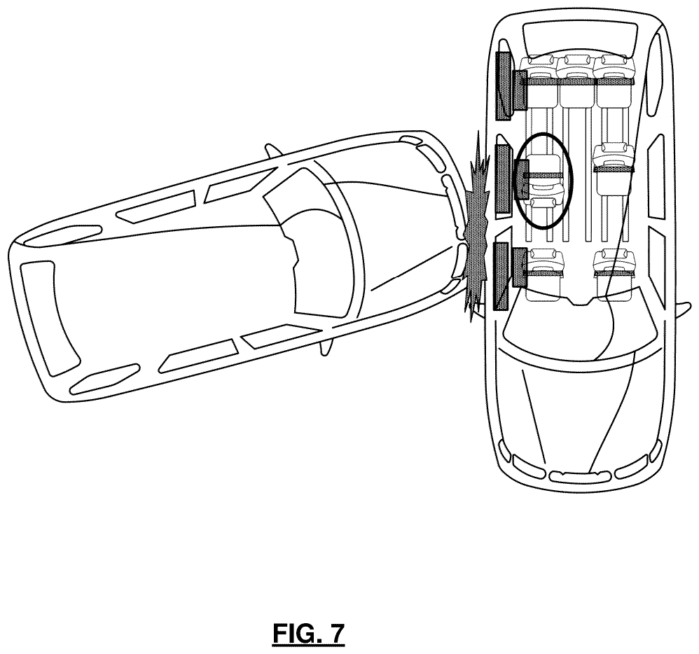

FIG. 7 is an illustration of an example seat arrangement and side (right side) collision. In the example of FIG. 7, the circled seat has been rotated to face rearward. This is unlike FIG. 6 where all of the seats are facing forward. For the example of FIG. 7, based on the seat directions, the collision direction, the seat occupancy, etc., the restraint control module 408 may actuate right side curtain airbags for all rows, the pretensioners for all of the seats, and seat side airbags of the seats on the right most side of the vehicle (where the collision occurred). In various implementations, the restraint control module 408 may not actuate restraints of unoccupied seats. Because the circled seat is facing rearward in the example of FIG. 7, its left seat side airbag may be actuated. The restraint control module 408 may determine which restraints to actuate based on the directions that the seats are facing.

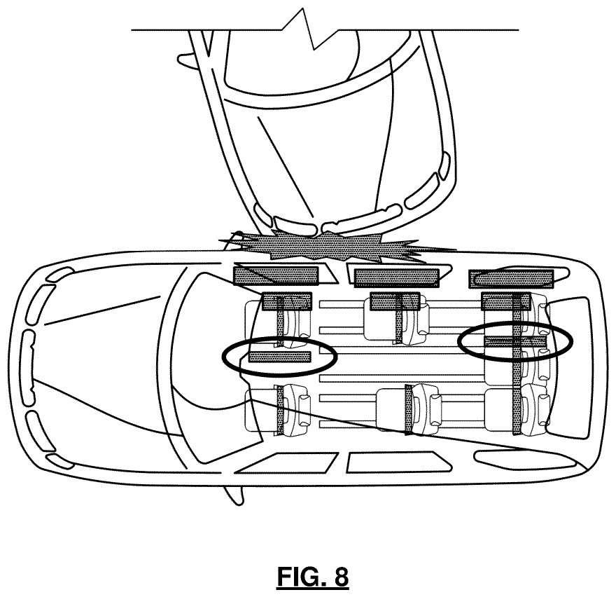

FIG. 8 is an illustration of an example seat arrangement and side (right side) collision. For the example of FIG. 8, based on the seat directions, the collision direction, the seat occupancy, etc., the restraint control module 408 may actuate right side curtain airbags for all rows, the pretensioners for all of the seats, and seat side airbags of the seats on the right most side of the vehicle (where the collision occurred). In various implementations, the restraint control module 408 may not actuate restraints of unoccupied seats. The restraint control module 408 may actuate occupant to occupant air bags circled in FIG. 8 to minimize or prevent one occupant from colliding with another occupant in response to the collision. The circled occupant to occupant air bags are disposed between seats and can be actuated between adjacent seats with occupants.

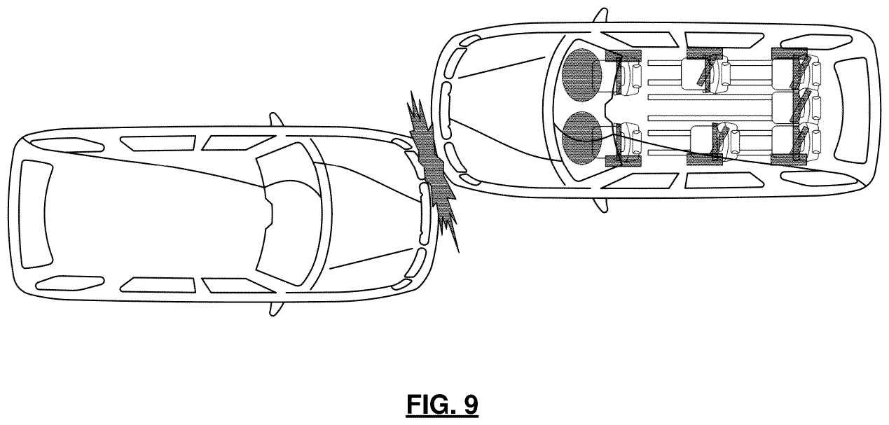

FIG. 9 is an illustration of an example seat arrangement and offset front side collision. For the example of FIG. 9, the restraint control module 408 may actuate frontal airbags, the pretensioners for all of the seats based on the seat directions, the collision direction, the seat occupancy, etc. Seat side airbags of the seats may also be actuated. In various implementations, the restraint control module 408 may not actuate restraints of unoccupied seats.

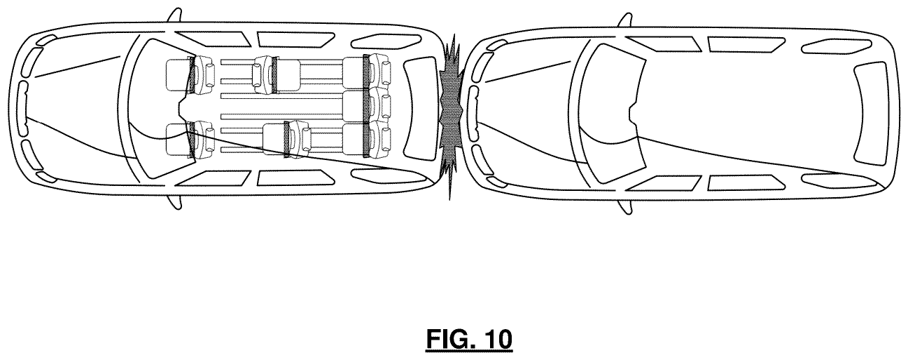

FIG. 10 is an illustration of an example seat arrangement and rear collision. For the example of FIG. 10, based on the seat directions, the collision direction, the seat occupancy, etc., the restraint control module 408 may actuate the pretensioners for all of the seats. The restraint control module 408 may not actuate any airbags. In various implementations, the restraint control module 408 may not actuate restraints of unoccupied seats.

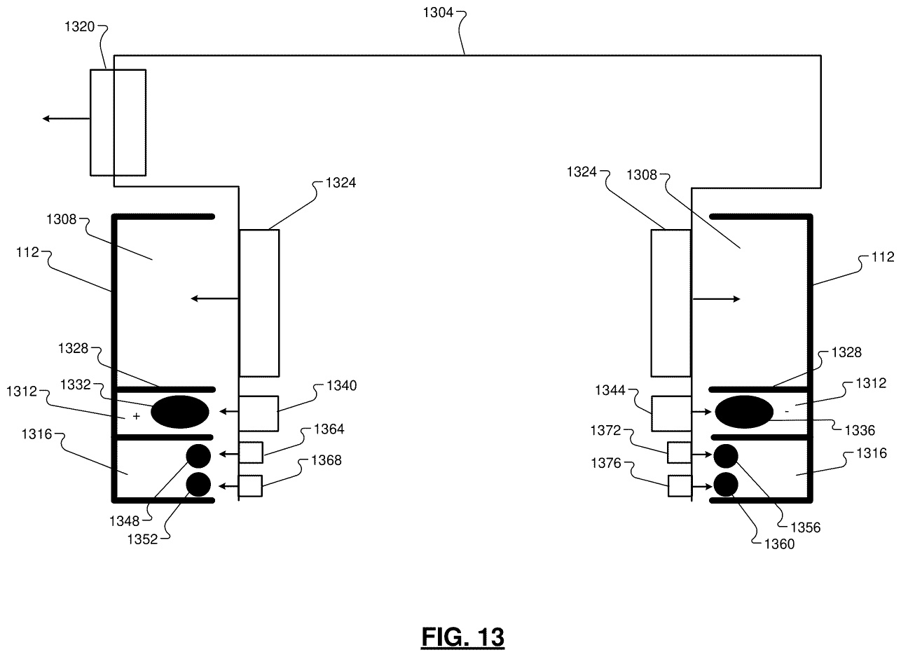

FIG. 13 is a cross sectional view including the first pair of tracks 112 and a base 1304 of a seat 124. Each track may include a first cavity 1308, a second cavity 1312, and a third cavity 1316. As discussed above, the seat 124 may include one or more actuators, such as actuator 1320 (e.g., lever, latch, arm, etc.). Actuation of the actuator(s) 1320 actuates one or more components of the seat 124 to engage the tracks 112, to electrically connect to electrical power, and to connect to communication lines. For example, actuation of the actuator 1320 in the direction illustrated by the arrow may cause track engaging portions (e.g., rollers) 1324 of the seat 124 to move in the direction illustrated by the arrows and extend into and rest upon vertically lower surfaces 1328 of the first cavities 1308 of the tracks 112. The track engaging portions 1324 retain the seat within the tracks 112 when disposed within the first cavities 1308 of the tracks 112.

Positive and negative power conductors 1332 and 1336 may be disposed in the second cavities 1312 of the tracks 112. Actuation of the actuator 1320 in the direction illustrated by the arrow also causes positive and negative electrical conductors 1340 and 1344 of the seat 124 to move in the direction illustrated by the arrows and contact the positive and negative power conductors 1332 and 1336, respectively. Electrical components of the seat 124 (e.g., the components of FIG. 2) receive electrical power from the vehicle 100 (e.g., one or more batteries) via the electrical contact between the power conductors 1332 and 1336 and the electrical conductors 1340 and 1344.

First communication lines (conductors) 1348 and 1352 may be disposed in the third cavities 1316 of one of the tracks 112. Second communication lines (conductors) 1356 and 1360 may be disposed in the third cavities 1316 of the other one of the tracks 112. Two sets of communication lines provides redundancy, for example, in the example of one of the pairs communication becoming broken or disconnected.

Actuation of the actuator 1320 in the direction illustrated by the arrow also causes first communication conductors 1364 and 1368 of the seat 124 to move in the direction illustrated by the arrows and contact the communication lines 1348 and 1352 respectively. Actuation of the actuator 1320 in the direction illustrated by the arrow also causes second communication conductors 1372 and 1376 of the seat 124 to move in the direction illustrated by the arrows and contact the communication lines 1356 and 1360 respectively. One or more components of the seat 124 (e.g., the control module 212 in the example of the communication module 224 being implemented remotely or the communication module 224) communicate with other components of the vehicle (e.g., the restraint control module 408) via the first communication lines 1348 and 1352 and/or the second communication lines 1356 and 1360.

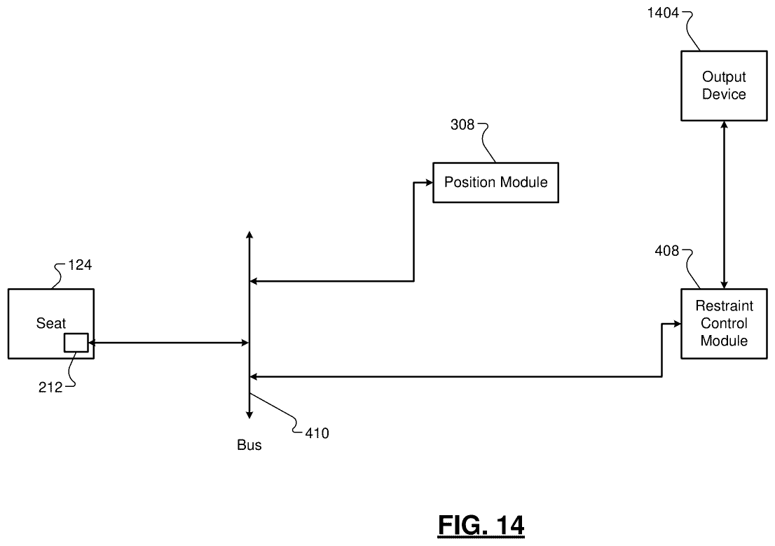

FIG. 14 incudes a functional block diagram of an example communication system of the vehicle 100. The control module 212 of each seat communicates with the restraint control module 408 via the communication lines of a track when the seat is engaged with the tracks as described above. The electrical components of the seat 124 also receive power via the power conductors of the tracks as described above.

When a seat is first connected to electrical power via a pair of tracks and the electrical components of the seat are powered, the control module 212 of the seat transmits to the communication module 224 a unique identifier of the seat and a type of the seat. Each seat may have a unique identifier stored in memory, such as a serial number that is unique to that seat. The seat type may include, for example, a manufacturer of the seat, and a type of the seat (e.g., bench, single seat, console, workstation, etc.).

The restraint control module 408 determines whether the seat is compatible with the vehicle based on the unique identifier and the seat type, such as by comparing the unique identifier and the seat type information with predetermined stored unique identifiers and seat type information of compatible seats. For example regarding compatibility, the restraint control module 408 may determine whether a vehicle manufacturer for the seat is the same as the manufacturer of the vehicle that the seat is connected to. If not, the restraint control module 408 may determine that the seat is not compatible with the vehicle and system. If the seat is not compatible, the communication module 224 may output an indicator that the seat is not compatible with the vehicle via one or more output devices, such as output device 1404. For example, the communication module 224 may output an audible indicator that the seat is not compatible via one or more speakers and/or output a visual indicator that the seat is not compatible via one of more displays. Verifying compatibility ensures that the seat is compatible with vehicle architecture, power requirements, interface requirements, vehicle manufacturer, communication formats, and other specifications.

If a seat is not compatible with the vehicle, the restraint control module 408 may not communicate with the seat and may therefore not actuate any of the restraints of the seat when a collision is detected. This may be to not incorrectly actuate one or more restraints. The restraint control module 408 may communicate with a seat, such as to actuate restraints of the seat, only when the seat is determined to be compatible with the vehicle.

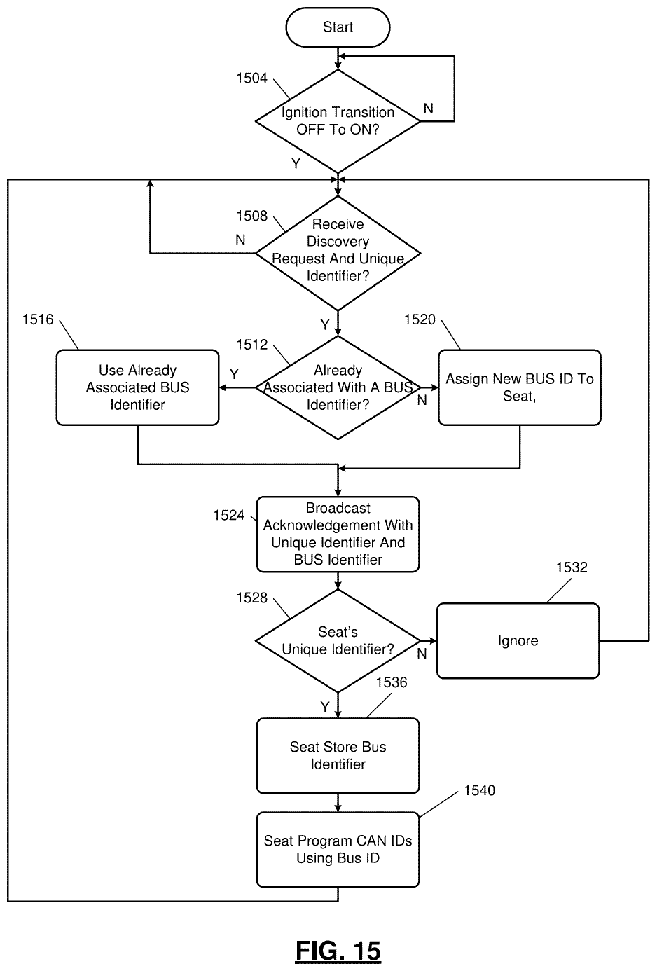

When the vehicle is powered on (e.g., key OFF to key ON transition) or a seat is connected to electrical power (e.g., seat connected to tracks or vehicle is powered on), the restraint control module 408 performs discovery. FIG. 15 includes a flowchart depicting an example method of discovery.

Referring to FIG. 15, control may begin with 1504. At 1504, the restraint control module 408 may determine whether the ignition of the vehicle (or the vehicle itself) transitioned from OFF to ON, such as in response to actuation of an ignition button, switch, key, etc. If 1504 is true, control continues with 1508. If 1504 is false, control may remain at 1504.

At 1508, the restraint control module 408 determines whether a request for discovery message with a unique identifier (e.g., serial number) has been received from the control module 212 of a seat. Each connected item may try to transmit a request for discovery message with its unique identifier in response to being powered. Only one control module 212 of one seat however can communicate its discovery message and unique identifier on the communication bus 410 at a given time. In other words, only one discovery request can win and occupy the communication bus 410 at a time. Thus, the ignition being turned on creates a race condition for the seats to transmit their respective discovery messages and unique identifiers. If 1508 is false, all connected seats have been addressed, and control remains at 1508. If 1508 is true, control continues with 1512. In various implementations, the restraint control module 408 and the control module 212 of the seat may perform authentication (e.g., encryption and decryption) to increase security of communications between different modules. Authentication may additionally or alternatively be performed for communication between the control module 212 of a seat and the position module 308, or between other modules for security. In various implementations, the control modules 212 of the seats may delay their first messages, such as based on unique identifier and/or other information. This may increase a likeliihood of the first transmission winning the race and reduce a chance of collision on the communication bus.

At 1512, the restraint control module 408 may compare the received unique identifier with a list of unique identifiers already associated with bus identifiers (BUS IDs) in an assignment table stored in memory (e.g., reset protected random access memory (RPRAM)) of the restraint control module 408. The restraint control module 408 determines whether the received unique identifier is already associated with a bus identifier. If 1512 is true, the received unique identifier is already assigned with a bus identifier, so the restraint control module 408 uses the bus identifier already associated with the received unique identifier at 1516. 1512 may happen, for example, if the control module 212 of the seat undergoes a reset or another event during the drive cycle between ignition ON and the next ignition OFF. Control may continue with 1524. If 1512 is true, control transfers to 1520.

At 1520, the restraint control module 408 assigns a unique bus identifier (not already included in the assignment table) to the seat and associates the unique bus identifier to the received unique identifier of the seat in the assignment table in the memory. The assignment table therefore includes a list of unique identifiers of seats (e.g., serial numbers) and associated respective unique bus identifiers. In various implementations, the restraint control module 408 may assign unique bus identifiers in a predetermined order, such as increasing numerical order (e.g., 1, 2, 3, 4, 5, etc.) or another suitable order. Control continues with 1524.

At 1524, the restraint control module 408 broadcasts an acknowledgement message with the unique identifier of the seat and the assigned bus identifier to the communication bus 410. The acknowledgement message is a response to the discovery request message.

At 1528, each control module 212 of each seat that is connected to the communication bus 410 receives the acknowledgement message, unique seat identifier, and assigned bus identifier. Each control module 212 determines whether the acknowledgement message is intended for it by comparing the unique identifier of its seat (e.g., serial number) to the unique seat identifier of the acknowledgement message. If its unique seat identifier is the same as the unique seat identifier of the acknowledgement message, control continues with 1536. If its unique seat identifier is different than the unique seat identifier of the acknowledgement message, that control module (of the seat with the unique seat identifier that is different than the unique seat identifier of the acknowledgement message) ignores the broadcast message at 1532, and control returns to 1508. This may be true during the discovery process. After the discovery process, various types of messages may be communicated, such as diagnostics, periodic synchronization, deployment messages, and other messages.

At 1536, the control module 212 of the seat (with the unique identifier matching the unique seat identifier of the acknowledgement message) stores the bus identifier of the acknowledgement message in memory (e.g., reset protected random access memory (RPRAM)) of that control module 212. At 1540, the control module 212 of the seat with the unique identifier that matches the unique seat identifier of the acknowledgement message programs its network (e.g., CAN) identifiers using the bus ID. The control module 212 periodically transmits the network identifiers with its bus identifier to the restraint control module 408. The network identifiers may indicate, for example, status of diagnostics regarding the seat and other indicators. Control returns to 1508. At the end of the drive cycle, (when the ignition transitions from ON to OFF), the assignment table of the restraint control module 408 and the stored bus identifiers of the control modules 212 may be erased or not preserved for a next drive cycle.

The discovery process includes requests for discovery, assignment of bus identifiers, and acknowledgements and provides traceability. While the example of the discovery process being performed between control modules of seats and the restraint control module 408 is provided, the present application is applicable to other implementations involving a master control module (e.g., the position module 308 or the restraint control module 408 or another module) performing the discovery process with remote modules (e.g., control modules of seats). Items other than seats may additionally or alternatively be connected to the communication bus 410 as discussed above. Also, while the discovery process and the present application is discussed in the context of restraint control systems, the present application is also applicable to other discovery processes in vehicles and even non-vehicle discovery processes. For example, a system may include: a communication bus; a remote control module; and a master control module configured to, in response to the remote control module receiving power and being connected to the communication bus: receive a unique identifier from the remote control module via a request message on the communication bus; determine whether the unique identifier is associated with a bus identifier in memory; when the unique identifier is associated with the bus identifier in memory of the master control module, transmit on the communication bus an acknowledgement message including (a) the unique identifier and (b) the bus identifier associated with the unique identifier; and when the unique identifier is not associated with any bus identifier in the memory: associate, in the memory, a unique bus identifier not already in the memory with the unique identifier; and transmit on the communication bus the acknowledgement message including (a) the unique identifier and (b) the bus identifier associated with the unique identifier.

Generally speaking, the discovery process includes a master control module and nodes to be discovered on a communication network. The nodes to be discovered on the communication network may be referred to as remote control modules. The discovery process involves the use of respective unique identifiers (e.g., serial numbers) of the remote control modules. The discovery process uses a message that is used by all remote control modules, which is the request for discovery message.

At the start of a drive cycle, all of the remote control modules that are connected to the communication network try to output their request for discovery message (and their unique identifier) to the communication network. The request for discovery is made to create a race condition for the remote control modules to request discovery. Only one of the remote control modules can win the communication network and transmit its request for discovery message. Other remote control modules wait but continue to try to request discovery and win the communication network.

When the master control module receives the request for discovery message, the master control module extracts the unique identifier and either (a) assigns a new bus identifier in the example of the unique identifier not being in the assignment table or (b) uses the bus identifier already associated with the unique identifier in the assignment table. The assigned bus identifiers are stored in association with the unique identifiers of the remote control modules in the assignment table in memory of the master control module, such as RPRAM. The assignment table therefore includes a list of (a) unique identifiers of remote control modules and (b) the associated respective bus identifiers. The assignment table is erased for each new drive cycle. Use of the RPRAM may protect against intended resets, unintended resets, and other events that may occur during the drive cycle.

The remote control module broadcasts the acknowledgement message to the communication network with the unique identifier of a remote control module and the assigned bus identifier. Since the acknowledgement message is broadcast, all of the remote control modules on the network will receive the acknowledgement message. Only the remote control module having the unique identifier of the acknowledgement message will accept the acknowledgement message. The other remote control modules with different unique identifiers will ignore the acknowledgement message. The remote control module having the unique identifier of the acknowledgement message learns the assigned bus identifier from the acknowledgement message for the remainder of the drive cycle and stores the assigned bus identifier in its memory, such as its RPRAM. The remote control module may also force a reset. Upon completing the reset (recovering after the reset), the remote control module will use the stored bus identifier to calculate all of the supported communication message identifiers to uniquely identify them from others communicating on the same communication network.

If a remote control module with an assigned bus identifier loses power during the drive cycle, it will proceed through the discovery process again. In this case, its unique identifier will have already been stored in the assignment table, so the master control module will use the already assigned bus identifier stored in the assignment table in the acknowledgement message.

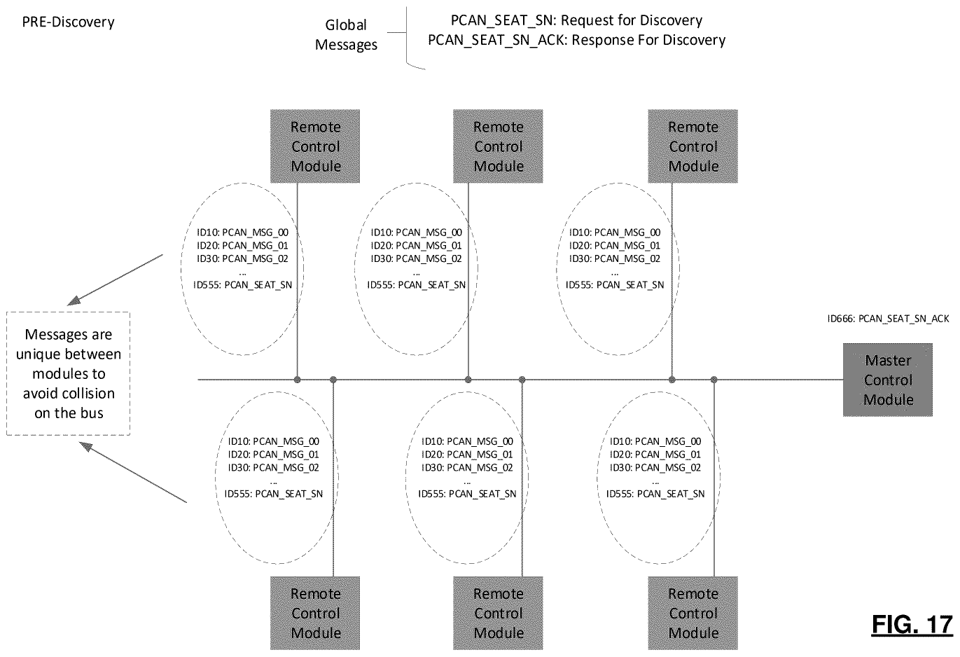

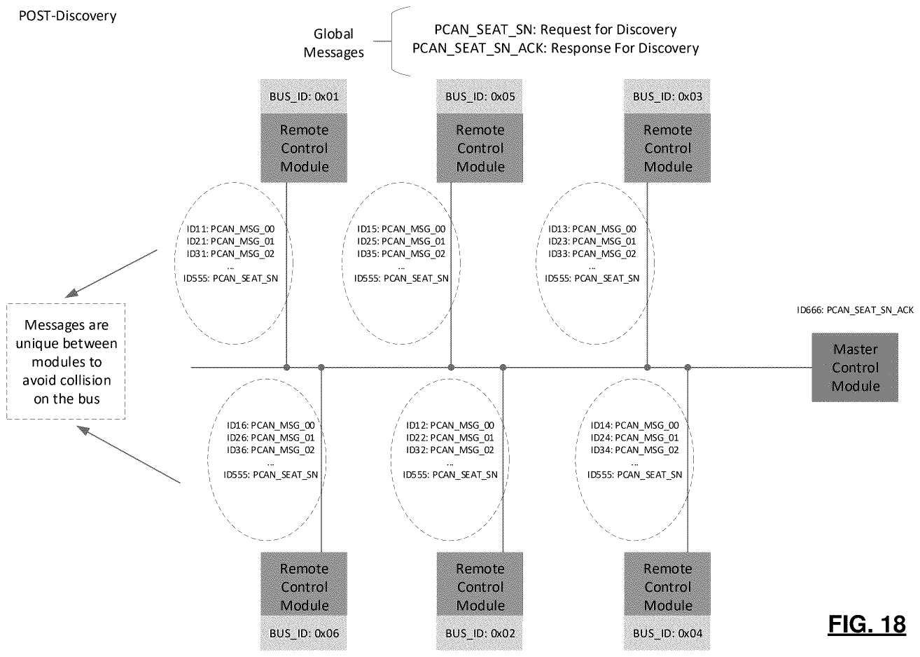

The discovery process described herein has plug and play capability so a remote control module can be added to the communication network during a drive cycle and will be discovered and able to communicate via the communication network. The discovery process allows only authorized (e.g., authenticated) and compatible remote control modules to be assigned a bus identifier. The discovery process confirms compatibility of the remote control modules with the entire network and vehicle. The discovery process allows nodes on the communication network to be discovered which provides the nodes to uniquely communicate on the network. Each message is uniquely identifiable and therefore enables a dynamic network where nodes can be added or removed at any time, and pre-assignment of identifiers is not needed. The discovery process is automated and does not use any external input. FIG. 17 includes a functional block diagram of an example of the communication system before the discovery process, and FIG. 18 includes functional block diagram of an example of the communication system after the discovery process.

In various implementations, the position module 308 may also determine an orientation (facing direction) of each seat. The position module 308 may determine the orientation of a seat, for example, using input from a variable reluctance or Hall effect sensor of the seat based on a toothed wheel that rotates with the seat (e.g., 1104 of FIG. 11). Additionally or alternatively, one or more cameras may be used to capture images of the passenger cabin 108, and the orientation of each seat may be determined based on orientations of the seat 124 within the image(s), for example, using object detection. In various implementations, since the positive and negative power conductors 1332 and 1336 may be disposed in different ones of a pair of tracks, the position module 308 may determine that the orientation of the seat is forward when conductor 1340 is connected to the positive conductor 1332 and the other conductor 1344 is connected to the negative conductor 1336. The position module 308 may determine that the orientation of the seat is backward when conductor 1340 is connected to the positive conductor 1332 and the other conductor 1344 is connected to the negative conductor 1336. The restraint control module 408 may actuate different restraints based on the orientation(s) of the seat(s) when a collision is detected.

The restraint control module 408 may determine which types of restraints and devices (e.g., seat belts, sensors, pretensioners, airbags, active head rests, etc.) a seat has based on the seat type and/or the unique identifier. For example, the restraint control module 408 may determine the restraints and devices of the seat using a lookup table of unique identifiers and/or seat types to types of restraints and devices.

The restraint control module 408 may determine a seating capacity (e.g., one seat, two seats, three seats) of a seat based on the seat type and/or the unique identifier. For example, the restraint control module 408 may determine the seating capacity of the seat using a lookup table of unique identifiers and/or seat types to seating capacities.

Based on the unique identifier, the restraint control module 408 may determine whether the item connected to a pair of tracks is a seat or another type of device, such as workstation, a cooler (e.g., a food and beverage cooler), a console, or another suitable type of device.

In various implementations, the control module 212 of each seat may perform diagnostics for that seat. Examples of diagnostics include, for example, whether a seat belt of the seat has a fault, whether an airbag of the seat has a fault, and other self-diagnostics for components of the seat. The control module 212 may communicate the results of its diagnostics to the communication module 224 using the identifier assigned to it. The communication bus is common to all of the modules communicating, but in various implementations the communication bus may include multiple busses. The restraint control module 408 may determine whether to actuate one or more restraints of a seat based on the diagnostics of the seat.

FIG. 16 is a flowchart depicting an example method of controlling actuation of the restraints of seats. Control begins with 1604, where the position module 308 determines the positions of the seats 124 as discussed above. The position module 308 may transmit the positions of the seats 124 to the seats with the seats' bus identifiers (or unique identifiers) at 1608. In this manner, the control module 212 of each seat 124 receives the present position of its seat 124 via its identifier and ignores the positions of the other seats (with other identifiers). The control module 212 of a seat selects its position by selecting the position transmitted with its bus identifier or unique identifier.

At 1612, the restraint control module 408 determines whether a collision of the vehicle 100 with one or more objects have occurred and, if so, a direction (e.g., front, rear, right side, left side, etc.) of the collision. If 612 is true, control continues with 1616. If 1612 is false, the restraint control module 408 may set all of the ISO code indicators to false (e.g., 0, NO) to not actuate any restraints, and control may return to 1604. If 1612 is true, control may continue with 1616.

At 1616, the restraint control module 408 sets the ISO code indicators based on the collision (e.g., magnitude) and direction. The restraint control module 408 may set one, more than one, or all of the ISO code indicators to true (e.g., 1, YES) to actuate one or more of restraints.

At 1620, the restraint control module 408 transmits (e.g., broadcasts) a message including the ISO code indicators on the bus 410 for all of the seats 124. The seats 124 receive their positions and orientations (or determine their orientations) from the position module 308 via the bus 410, such as by selecting the position and orientation information on the bus 410 associated with the unique identifier of that seat.

At 1624, the control modules 212 of the seats 124, respectively, each determine whether and which of its restraints to actuate based on the position and orientation of the seat given the ISO code indicators. At 1628, the control modules 212 of the seats 124, respectively, selectively actuate ones of the restraints of that seat.

In the example of an ISO code for left side, second row, pretensioner indicating to actuate (e.g., 1), a seat on the left side of the vehicle in the second row (row 2), may actuate its pretensioner in response to this ISO code indicator. A seat on the right side of the vehicle though or a seat in the first row or the third row may not actuate its pretensioner in response to this ISO code indicator. In this manner, the control modules 212 of the seats 124 individually actuate ones of the restraints of their seats 124 based on their positions and orientations according to the ISO code indicators.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A restraint control system of a vehicle, comprising:
a communication bus;
a control module of a seat of the vehicle configured to selectively actuate restraints of the seat; and
a module configured to, in response to the control module of the seat receiving power and being connected to the communication bus:
receive a unique identifier from the control module of the seat via a request message on the communication bus;
determine whether the unique identifier is associated with a bus identifier in memory;
when the unique identifier is associated with the bus identifier in memory of the module, transmit on the communication bus an acknowledgement message including (a) the unique identifier and (b) the bus identifier associated with the unique identifier; and
when the unique identifier is not associated with any bus identifier in the memory:
associate, in the memory, a unique bus identifier not already in the memory with the unique identifier; and
transmit on the communication bus the acknowledgement message including (a) the unique identifier and (b) the bus identifier associated with the unique identifier.

2. The restraint control system of claim 1 wherein the unique identifier is a serial number.

3. The restraint control system of claim 1 wherein:
the module is configured to authenticate communication with the control module of the seat; and
the control module of the seat is configured to authenticate communication with the module.

4. The restraint control system of claim 1 wherein the control module of the seat is configured to:
receive from the bus (a) the unique identifier and (b) the bus identifier associated with the unique identifier;
determine whether the unique identifier received from the communication bus is the same as the unique identifier;
store the bus identifier in second memory of the control module; and
set communication bus identifiers based on the bus identifier of the seat.

5. The restraint control system of claim 4 wherein the control module of the seat is configured to force a reset of itself before the setting the communication bus identifiers.

6. The restraint control system of claim 4 wherein:
the memory of the module is reset protected random access memory (RPRAM); and
the second memory of the control module is RPRAM.

7. The restraint control system of claim 4 wherein the control module is configured to periodically output the communication bus identifiers to the communication bus.

8. The restraint control system of claim 4 wherein the control module is configured to ignore messages on the communication bus with unique identifiers that are different than the unique identifier.

9. The restraint control system of claim 1 further comprising:
a second control module of a second seat of the vehicle configured to selectively actuate second restraints of the second seat,
wherein the module is further configured to, in response to the second control module of the second seat receiving power and being connected to the communication bus:
receive a second unique identifier from the second control module of the second seat via a second request message on the communication bus;
determine whether the second unique identifier is associated with a bus identifier in memory;
when the second unique identifier is associated with the bus identifier in memory of the second module, transmit on the communication bus a second acknowledgement message including (a) the second unique identifier and (b) the bus identifier associated with the second unique identifier; and
when the second unique identifier is not associated with any bus identifier in the memory:
associate, in the memory, a second unique bus identifier not already in the memory with the second unique identifier; and
transmit on the communication bus the second acknowledgement message including (a) the second unique identifier and (b) the bus identifier associated with the second unique identifier.

10. The restraint control system of claim 1 wherein no bus identifiers are associated with unique identifiers in the memory in response to the vehicle transitioning from OFF to ON.

11. The restraint control system of claim 1 wherein the seat is configured to engage pairs of tracks of a floor of a passenger cabin of the vehicle, the pairs of tracks arranged parallel to a longitudinal axis of the vehicle, and the pairs tracks are configured to engage two or more seats on each pair of tracks.

12. The restraint control system of claim 1 further comprising a restraint control module configured to, in response to detection of a collision of the vehicle:
set indicators of International Standards Organization (ISO) codes for the collision; and
broadcast the indicators of the ISO codes to the communication bus.

13. The restraint control system of claim 12 wherein the control module of the seat is configured to:
receive the indicators of the ISO codes via the communication bus;
select which ones of the restraints of the seat to actuate based on a position of that seat and the indicators of the ISO codes;
actuate the selected restraints of that seat; and
not actuate non-selected ones of the restraints of that seat.

14. The restraint control system of claim 12 wherein the ISO codes are longitudinal row, latitudinal position, and restraint specific.

15. The restraint control system of claim 12 wherein the module is further configured to:
determine the position of the seat within the passenger cabin of the vehicle; and
transmit the position of the seat to the seat via the communication bus.

16. The restraint control system of claim 1 wherein the module is further configured to determine whether the one of the seats is compatible based on the unique identifier of the one of the seats.

17. The restraint control system of claim 1 wherein:
the control module of the seat is further configured to transmit a type of the seat to the module via the communication bus; and
the module is further configured to determine whether the one of the seats is compatible based on the type of the seat.

18. The restraint control system of claim 1 wherein:
the control module of the seat is further configured to transmit a manufacturer of that seat to the module via the communication bus; and
the module is further configured to determine whether the seat is compatible based on the manufacturer of the seat.

19. The restraint control system of claim 1 wherein only the request message from the control module can occupy the communication bus at a time.

20. A restraint control method for a vehicle, comprising:
by a control module of a seat of the vehicle, selectively actuating restraints of the seat; and
by a module separate from the control module, in response to the control module of the seat receiving power and being connected to a communication bus:
receiving a unique identifier from the control module of the seat via a request message on the communication bus;
determining whether the unique identifier is associated with a bus identifier in memory;
when the unique identifier is associated with the bus identifier in memory of the module, transmitting on the communication bus an acknowledgement message including (a) the unique identifier and (b) the bus identifier associated with the unique identifier; and
when the unique identifier is not associated with any bus identifier in the memory:
associating, in the memory, a unique bus identifier not already in the memory with the unique identifier; and
transmitting on the communication bus the acknowledgement message including (a) the unique identifier and (b) the bus identifier associated with the unique identifier.
